(19) United States
(12) Patent Application Publication
(10) Pub. No.: US 2012/0299284 A1
(43) Pub. Date: Nov. 29, 2012

(54) Shield for Weight Gauge Box

(76) Inventor: Gerald Theesfeld, Emmetsburg, IA (US)

(21) Appl. No.: 13/460,975

(22) Filed: May 1, 2012

Related U.S. Application Data
(62) Division of application No. 12/556,949, filed on Sep. 10, 2009, now abandoned.
(60) Provisional application No. 61/095,737, filed on Sep. 10, 2008.

(51) Int. Cl. B62D 25/18

(52) U.S. Cl. 280/851

(57) ABSTRACT

A shield for a component, such as a weight gauge box, of a tractor trailer is described. The shield includes a bracket for mounting of a shield member, such as a heavy rubber mud flap, that mounts the flap rearward of protectable components and forward of the wheels of the tractor trailer. The shield limits the likelihood of damage to forward components by impact from objects thrown by the wheels and also limits the deposit of road dirt and grime thrown by the wheels.

### RELATED APPLICATIONS

The present application is a divisional to U.S. patent application Ser. No. 12/556,949 on Sep. 10, 2009, and claims priority to the provisional application filed Sep. 10, 2008.

### BACKGROUND OF THE INVENTION

The invention relates generally to tractor trailers and, more specifically, to a shield or mud flap for a weight gauge box mounted forward of wheels of a tractor trailer.

Weight gauges are in common use on trailers towed by semi-tractors. Most such trailers are equipped with an air spring suspension system. Proper use of the air spring system requires adjustment of the pneumatic pressure systems in response to changes in the weight of the load being carried by the tractor trailer. The controls for these systems have to be accessible to operators and are frequently located in a box mounted on the side of the tractor trailer forward of the rear wheels of the trailer. To gain access to the controls for needed adjustments to the system, the operator opens a door on the box, makes the adjustment, and then closes and secures the door. The rear wheels of the trailer throw dirt, water, mud and other road debris toward the box as the trailer is driven down the road so that the box is subject to damage in addition to be dirty or possible coated in mud that prevents easy access to the controls by the operator.

A method is needed to limit the likelihood of damage to the weight gauge box and to reduce the amount of dirt, mud and other road debris that is deposited on the weight gauge box.

### SUMMARY OF THE INVENTION

The present invention consists of a shield, preferably in the form or an elastomeric flap, mounted on a tractor trailer between a weight gauge box and the wheels of the tractor trailer. The shield limits the amount of road debris that impacts and may be deposited on the weight gauge box. While such shields or mud flaps are known for use behind the wheels of a tractor trailer to limit throwing of road debris onto trailing or adjacent vehicles, no previous application of such shields forwardly of the wheels is known.

### BRIEF DESCRIPTION OF THE FIGURES

FIG. 1 is a side view of a tractor trailer showing a weight gauge box mounted on the side of the trailer below the bed and forward of wheels of the trailer.

FIG. 2 is a rear perspective view corresponding to FIG. 1.

FIG. 3 if a perspective view of a preferred embodiment of a shield of the present invention.

FIG. 4 is a side view of the shield of FIG. 3 mounted on the tractor trailer with the flap rearward of the weight gauge box.

FIG. 5 is a rear view showing how the shield of the present invention protects the weight gauge box.

### DETAILED DESCRIPTION OF THE INVENTION

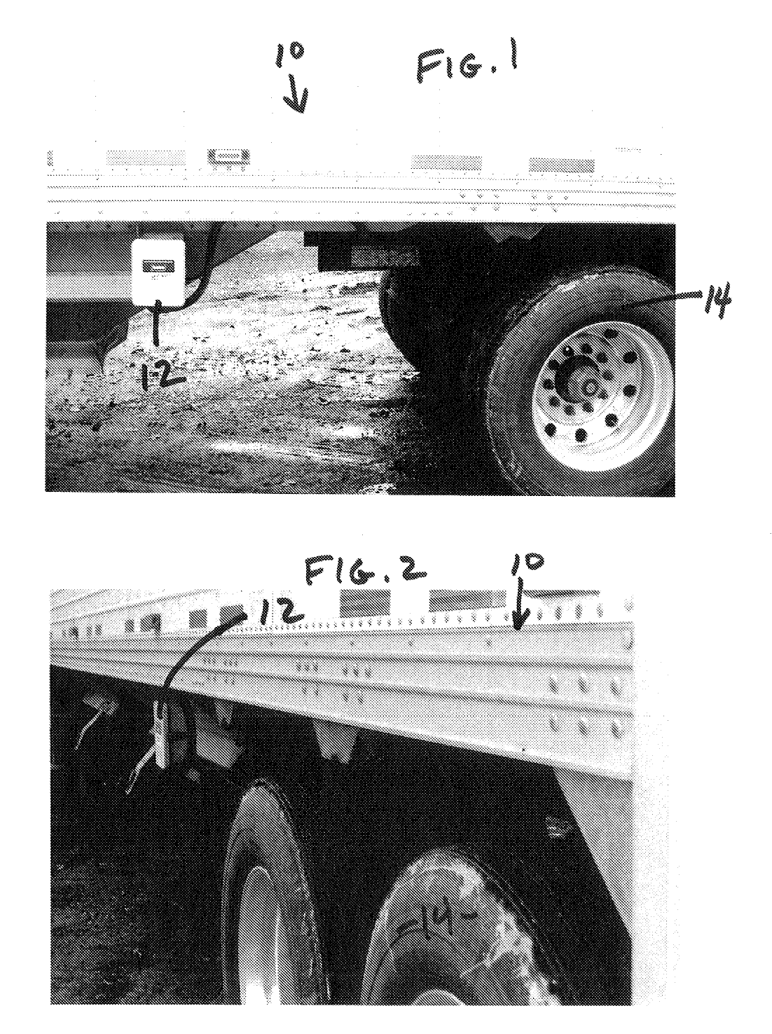

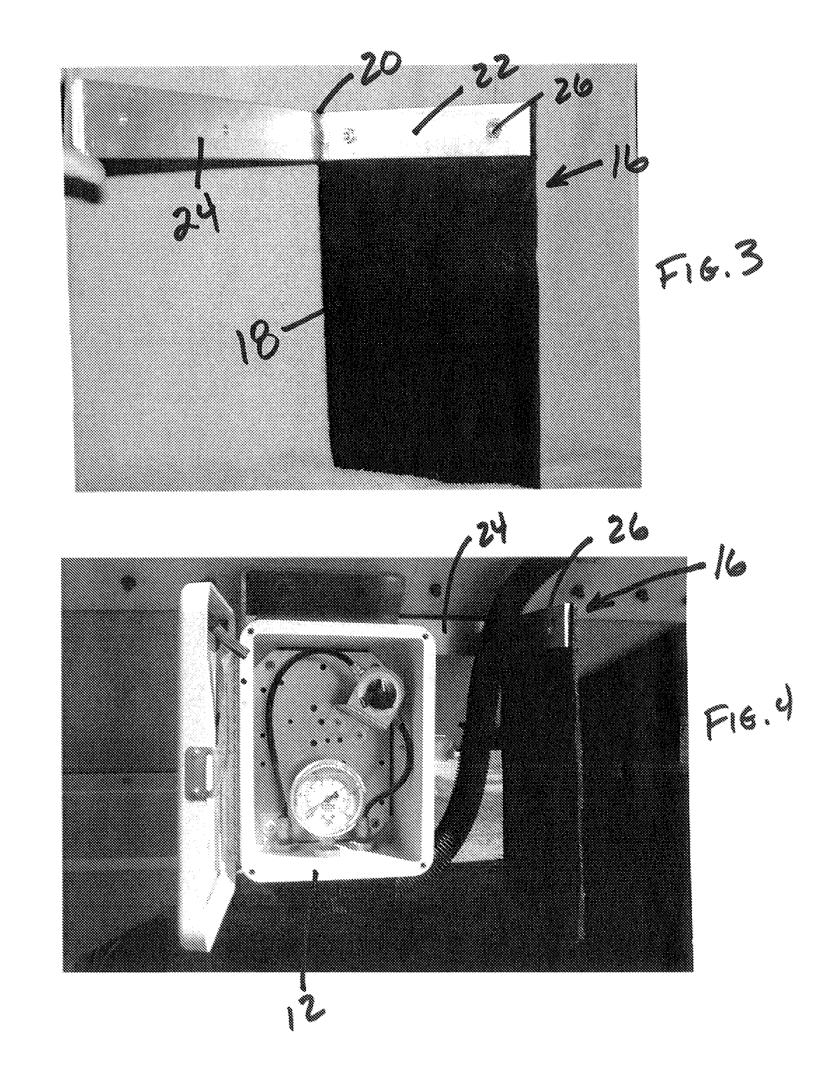

Illustrated in FIGS. 1 and 2, generally at 10, is a tractor trailer on which is mounted a weight gauge box 12 in common use to control the air spring suspension system of the tractor trailer 10. The weight gauge box 12 is mounted forwardly of the wheels 14 of the tractor trailer 10.

In a preferred embodiment of the invention, a shield 16 is constructed of an L-shaped bracket 20, having a flap mounting arm 22 and a trailer mounting arm 24 (FIG. 3). An elastomeric material, such as a heavy rubber sheet 18, is attached to the flap mounting arm 22. In the preferred embodiment, a pair of nut and bolt combinations 26 are used to attached the sheet 18 to the arm 22, although many other methods of attachment are known to those skilled in the art.

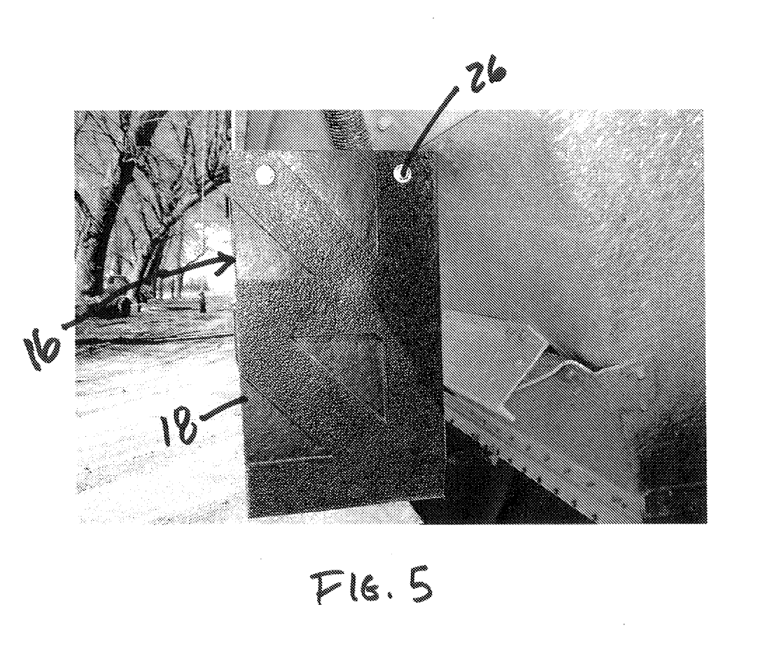

The shield 16 is mounted on the trailer 10 between the weight gauge box 12 and the wheels 14 (FIG. 4). The size and shape of the sheet 18 and the mounting position of the shield 16 are selected to prevent or limit road debris or grime thrown up by the wheels 14 from impacting the weight gauge box 12, thus protecting the weight gauge box and limiting the amount of dirt and grime deposited on the box 12 (FIG. 5).

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A shield for protecting a component attached to a tractor trailer forwardly of the first rear wheel of the tractor trailer, comprising:
(a) a mounting bracket, mounted forwardly of the foremost rear wheel;
(b) a shield member attached to the mounting bracket; and
(c) a structure mounting the mounting bracket on the tractor trailer forwardly of the wheel in a position to limit the impact or deposit of road debris or grime thrown by the wheel toward forwardly mounted components.

2. A shield as defined in claim 1, wherein the shield member hangs below the mounting bracket.

3. A method of protecting components from road debris, comprising:
(a) providing at least one tire;
(b) providing a mud flap assembly further comprising a mounting bracket for attachment to the underside of vehicle or trailer, the bracket being attached to a shield member;
(c) mounting the mud flap assembly rearward of the protectable component and forward of the tire, such that the shield member acts to shield forward components from road debris sent componantward from the tire.
